(19) United States
(12) Patent Application Publication
(10) Pub. No.: US 2016/0271612 A1
(43) Pub. Date: Sep. 22, 2016

(54) Modular Tray for Holding Plurality of Cell Culture T-Flasks at a Solution Angle

(71) Applicant: Mernaz Masoumi, Laguna Nigel, CA (US)

(72) Inventor: Mernaz Masoumi, Laguna Nigel, CA (US)

(21) Appl. No.: 15/077,890

(22) Filed: Mar. 22, 2016

Related U.S. Application Data
(60) Provisional application No. 62/136,617, filed on Mar. 22, 2015.

(51) Int. Cl. B01L 9/00

(52) U.S. Cl. CPC B01L 9/00; B01L 2200/028; B01L 2300/0809

(57) ABSTRACT

A modular tray for removably holding a plurality of cell culture t-flasks (t-flasks) at a solution angle is described, discussed and disclosed. Such t-flasks may be held within the modular tray in a manner which forms a solution angle for each held t-flask, such that a bottom surface of the t-flask is minimally raised up off of the inside resting surface of the modular tray, while a bottom edge of the t-flask rests upon the inside resting surface, in order to prevent media within the t-flask from wetting contamination prone regions of the t-flask, such as a neck and a vent cap, which reduces the probability of the held t-flask containing cells and media from becoming contaminated. Additionally, each modular tray may be removably coupled to another modular tray to form an array or a matrix of modular trays.

### PRIORITY NOTICE

The present application claims priority under 35 U.S.C. §119(e) to U.S. Provisional Patent Application Ser. No. 62/136,617 filed on Mar. 22, 2015, the disclosure of which is incorporated herein by reference in its entirety.

### TECHNICAL FIELD OF THE INVENTION

The present invention relates in general to apparatus for arranging, organizing, and holding a plurality of cell culture t-flasks (t-flasks) and more specifically to a modular tray for arranging, organizing, and holding the plurality of t-flasks such that media within the plurality of t-flasks does not wet the vent cap and/or neck regions of the plurality of t-flasks.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Cell culture t-flasks (t-flasks) are a type of bioreactor intended to growth various cell cultures within the t-flask which are immersed in and feeding from a liquid media. T-flasks are prior art, see the FIG. 1 series of drawings in general for various views and depictions of t-flasks. Such t-flasks are generally transparent plastic or glass vessels in rectangular or trapezoidal prism shapes, with canted necks and vent caps. Further, such t-flasks come in various standard sizes from a number of laboratory supply vendors, such as BD Falcon®. For example, standard sizes are T-25, T-75, and T-150, where the numeral reference generally refers to an approximate surface area in square centimeters (cm²) of one of the two larger interior rectangle regions of the t-flask, with the canted neck point away.

In growing various cell cultures this surface area variable of a given bioreactor, such as a t-flask, may be important for two reasons. For one, in many types of cell cultures the culture of cells is specifically being grown on a flat substrate, i.e. the cells adhere to a flat substrate and so the surface area variable becomes important. In a given t-flask this substrate is the larger interior rectangle region with the canted neck pointing away from the substrate. Thus, such a surface area is maximized when the interior larger rectangle region is parallel with the surface the t-flask is resting upon, i.e. the interior larger rectangle region is lying flat. Such cells which have adhered to this flat substrate will tend to grow until the surface area is fully colonized. To facilitate continued growth once a t-flask substrate has been colonized more media may be added; however, because the t-flask was lying flat, if too much media is added the vent cap can become wetted and the probability of contamination increased—as further explained below.

And secondly, living cells must engage in various metabolic reactions for the cells to live and reproduce and such metabolic reactions require an exchange of gasses, such as carbon dioxide. As examples of metabolic reactions, depending upon the cell types and other factors, two common reactions are respiration (e.g. via the Krebs cycle) or various fermentation reactions. Because there is a constant need for gas exchange, optimal cellular growing conditions dictate maximizing the surface area of the gas-liquid interface so as to maximize gas exchange. In a rectangular prism shaped t-flask, this means lying the t-flask flat onto a flat surface, versus leaving the t-flask upright which would minimize the surface area of the gas-liquid interface.

However, laying a t-flask flat so as to maximize the surface area of the gas-liquid interface has been found to create a serious problem, the problem of increasing the probability of contamination. The usefulness of running experiments on any given set of cell cultures rests upon knowing exactly what type of cells are present within a given t-flask and assuring there are no biological contaminants, which could render the experiment useless. Thus, prior to entry of a given set of cells to a t-flask the t-flask is sterilized and the given set of cells are introduced into the sterile t-flask using various aseptic techniques and supporting equipment such a various types of hoods or clean rooms. But because the set of cells require continuous supply of appropriate gasses, there must be some continual entry into what would otherwise be a sealed system. Thus, t-flasks often have vent caps, which are typically attached to as well as exposed to some gas source, such as carbon dioxide. And thus there is always some inherent probability of contamination by from various undesirable biological materials, such as various microbes and fungi, entering the t-flask through the vent cap region. Contaminants may enter the system through the gas line or even potentially via the vent caps seal, by Brownian motion. It has been found that this inherent probability of contamination is greatly increased when the nutrient rich media wets the neck and/or vent cap region, because now for example, the small number of spores which find their way to the vent cap or neck region now have a source of nutrients. This problem of contamination is further compounded by a common industry practice of housing t-flasks with cell cultures and media in generally warm incubators (e.g. many incubators are maintained at approximately 37 degrees Celsius), which are often also humid environments. Such ideal conditions as found in an incubator encourage unwanted microbial and fungal spores to enter into a growth phase and potentially contaminate the cells within a given t-flask. To this end, t-flasks have canted necks which angle the t-flask opening, which is capped with a vent cap away from the media. However, the use of canted necks is a limited solution, because if enough media is poured into a given t-flask, when the t-flask is lying flat there may be some undesirable wetting of these contamination prone regions, i.e. wetting of the neck and/or vent cap.

There is a need in the art for an apparatus which partially raises what would otherwise be a flat surface of the t-flask lying flat against a surface to some angle off of the flat surface, such that the contamination prone regions of the neck and vent cap are not wetted by the media. But such an apparatus should not utilize too large of an angle, because as the angle increases the surface area of the gas-liquid interface decreases. Additionally, it would be desirable if such an apparatus could also be used to arrange, organize, and contain t-flasks, which would further aid in the running of various cell culture experiments.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a modular tray for holding a plurality of cell culture t-flasks (t-flasks) at a solution angle. Such t-flasks may be held within the modular tray in a manner which forms a solution angle, such that a bottom surface of the t-flask is minimally raised up off of the inside resting surface of the modular tray, while a bottom edge of the t-flask rests upon the inside resting surface, in order to prevent media within the t-flask from wetting contamination prone regions of the t-flask, such as a neck and a vent cap, which reduces the probability of the held t-flask containing cells and media from becoming contaminated. Additionally, each modular tray may be removably coupled to another modular tray.

It is an objective of the present invention to provide a modular tray which prevents media and cells within a t-flask from wetting contamination prone regions, such as the t-flask's neck and/or vent-cap.

It is another objective of the present invention to provide a modular tray which maximizes the surface area of the gas-liquid interface between the headspace in the t-flask and the liquid media, while simultaneously preventing the media from wetting the contamination prone regions.

It is another objective of the present invention to provide a modular tray which may contain a plurality of t-flasks, for example, and without limiting the scope of the present invention, a modular tray which may contain from three to seven t-flasks, such that the t-flasks area side-by-side in a single horizontal line, with a longitudinal length of a held t-flask being parallel to a pair of transverse rims of the modular tray.

It is another objective of the present invention to provide a modular tray where t-flasks may be held in a vertical fashion, one on top of the other.

It is another objective of the present invention to provide a modular tray with modular capabilities, such that one modular tray may be removably coupled to another modular tray to form a matrix of modular trays. For example, and without limiting the scope of the present invention, a two-by-three matrix of modular trays may be utilized, which is six modular trays total, arranged two deep and three across or three deep and two across.

It is yet another objective of the present invention to provide a modular tray and/or matrix of modular trays such that t-flasks may be arranged and organized in various desirable groupings to aid in various cell culture experiments.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) depicts prior art of a t-flask upon which this invention operates, shown from a perspective view.

FIG. 1(b) depicts prior art t-flask shown from longitudinal side view of the t-flask, with media inside of the t-flask, while the t-flask lies flat upon a flat surface.

FIG. 1(c) depicts prior art t-flask shown from longitudinal side view of the t-flask, with media inside of the t-flask, while the t-flask is raised up from a flat surface at a solution angle.

FIG. 2(a) depicts an exemplary embodiment of a modular tray, holding a plurality of t-flasks, and shown from a top view.

FIG. 2(b) depicts an exemplary embodiment of a modular tray, holding a t-flask, shown from a transverse cross-sectional view of the modular tray.

FIG. 2(c) depicts the exemplary embodiment of FIG. 2(a) from the same top view, but without the plurality of t-flasks.

FIG. 2(d) depicts the exemplary embodiment of FIG. 2(b) from the same transverse cross-sectional view, but without the t-flask.

FIG. 3 depicts an exemplary embodiment of a matrix of modular trays, where each modular tray is holding a plurality of t-flasks in a horizontal array, all shown from an exploded top view.

FIG. 4(a) depicts an exemplary embodiment of a modular tray, with a plurality of compartments, each sized to accommodate a single t-flask, shown from a perspective view.

FIG. 4(b) depicts the exemplary embodiment of FIG. 4(a) from a top view. In addition each compartment may comprise a graphical indicator to facilitate the tracking of various cell culturing experiments.

FIG. 5(a) depicts an exemplary embodiment of a vertically stackable modular tray, shown from a perspective view.

FIG. 5(b) depicts an exemplary embodiment of two connected modular trays which may be either in a horizontal configuration or a vertical configuration with respect to each other, shown from a perspective view.

FIG. 5(c) depicts the exemplary embodiment of FIG. 5(b) where the two connected modular trays are in the vertical configuration, shown from a perspective view.

### REFERENCE NUMERAL SCHEDULE/LISTING

100 t-flask 100

101 bottom edge 101 (of t-flask)

102 bottom surface 102 (of t-flask)

103 contamination prone regions 103

104 neck 104

105 vent cap 105

199 gas-liquid interface 199

200 modular tray 200

201 solution angle 201

202 inside resting surface 202

203 inside transverse width 203

204 inside longitudinal length 204

205 pair of longitudinal rims 205

206 inside height 206

207 top edge 207 (of longitudinal rims 205)

208 outside surface 208 (of longitudinal rim 205)

209 pair of transverse rims 209

210 outside perimeter 210 (of modular tray)

211 pair of longitudinal bases 211

212 pair of transverse bases 212

213 plurality of protruding tabs 213

214 plurality of receiving tabs 214

215 thickness 215 (of longitudinal rim 205)

300 matrix of modular trays 300

400 modular tray 400

404 inside compartment width 404

409 transverse rims 409

419 dividers 419

420 graphical experiment indicator 420

421 compartment 421

501 vertically stackable modular tray 501 (modular tray 501)

509 transverse rim 509

513 vertical tabs 513

514 receiving ports 514 (for vertical tabs 513)

521 vertical stacking height 521 (height 521)

551 foldable vertical modular tray 551 (modular tray 551)

552 lower strut 552

553 upper strut 553

554 lower ratchet type locking mechanism 554

555 upper ratchet type locking mechanism 555

559 pair of transverse rims 559

### DETAILED DESCRIPTION OF THE INVENTION

A modular tray for removably holding a plurality of cell culture t-flasks (t-flasks) at a solution angle is described, discussed and disclosed. The modular tray may generally comprise an inside resting surface bounded by a pair of longitudinal rims and a pair of transverse rims. Furthermore, the modular tray may further comprise a means for removably coupling one modular tray to another modular tray such that a matrix of modular trays is formed, which allows for greater flexibility in arranging and organizing t-flasks to support various cell culturing experiments. Each of these elements is discussed below before the discussion turns to the figures.

In various exemplary embodiments, the inside resting surface may receive a bottom edge of a removably held t-flask. The inside resting surface may comprise an inside transverse width and an inside longitudinal length. In various embodiments, the transverse width may be less than the longitudinal length. The inside longitudinal length may be perpendicular to the inside transverse width.

In various exemplary embodiments the pair of longitudinal rims may be parallel to the inside longitudinal length and arise upwardly and perpendicularly from the inside resting surface. Each of the two longitudinal rims may be separated by the inside transverse width such that the pair of longitudinal rims bound the inside transverse width.

Additionally, each longitudinal rim may rise to an inside height. At a top of this inside height may be a top edge of the longitudinal rims. There is a combination of dimensions of the inside transverse width, the inside height, and the pair of longitudinal rims which may force a neck of the held t-flask to rest upon this top edge of one of the longitudinal rims. When this combination of dimensions forces the neck to rest upon the top edge of one of the longitudinal rims, a solution angle is formed. The solution angle is a particular angle between the inside resting surface of the modular tray and a bottom surface of the t-flask, such that wetting of contamination prone regions is prevented when the t-flask is held stationary in the modular tray. The solution angle is defined as the minimal angle which partially raises a bottom surface of the t-flask off of the inside resting surface, such that wetting of contamination prone regions is prevented when the t-flask is held stationary in the modular tray. A t-flask's contamination prone regions may comprise the neck region and/or the vent-cap region of that given t-flask. Note, increasing such an angle beyond this minimum angle is not optimal because as such an angle increases, the surface area of the gas-liquid interface becomes smaller. Additionally, for those cell cultures which prefer to adhere to a substrate, increasing such an angle tends to reduce cell density along the t-flask's bottom inside surface, which may serve as an adherence substrate for such cells. Thus a particular solution angle is fixed and realized by a particular combination of dimensions for a given standardized size of t-flask to be held within the modular tray.

The combination of dimensions of the inside transverse width, the inside height, and the pair of longitudinal rims which result in the t-flask's neck resting upon the top edge of one of the longitudinal rims and forming a solution angle is specified and predetermined, i.e. given definiteness, with respect to a given standard size of t-flask. For example, the combination of dimensions of the inside transverse width, the inside height, and the pair of longitudinal rims that create the solution angle for a T-25 t-flask will be a different set of dimensions than the dimension combination which works for a T-75 t-flask.

A given combination of dimensions of the inside transverse width, the inside height, and the pair of longitudinal rims works as follows: For a given standardized size of t-flask, if the inside transverse width is too wide, then one of the longitudinal rims will be unavailable to prevent the t-flask from sliding all the way into the modular tray such that t-flask is lying flat upon the inside resting surface and the contamination prone regions now exposed to media wetting. Or if the transverse width is too narrow, the t-flask tends to be pushed towards the upright position minimizing the surface area of the gas-liquid interface. Or if the inside height is too small, the t-flask will tend to lay flat upon the inside resting surface, allowing the contamination prone regions to be wetted by media. Or if the inside height is too high, the t-flask will tend to be in a more upright position minimizing the surface area of the gas-liquid interface. Thus for a particular standardized size of t-flask (e.g., T-25), there is a limited combination of dimensions of the inside transverse width, the inside height, and the pair of longitudinal rims which result in the solution angle being formed.

Additionally, while the neck rests upon the top edge of one of the longitudinal rims, a vent cap of the held t-flask may hang partially below the top edge of the one longitudinal rim towards an outside surface of that one longitudinal rim such that the outside surface of the one longitudinal rim provides a barrier against the vent cap. In this additional way, the t-flask is prevented from sliding into the inside resting surface such that t-flask lays flat within the inside resting surface and thus prevents media from wetting contamination prone regions. Additionally, in this way, the solution angle is preserved.

The pair of transverse rims may be parallel to the inside transverse width and perpendicular to the pair of longitudinal rims. Further the pair of transverse rims may arise upwardly and perpendicularly from the inside resting surface and may be situation such that each transverse rim is separated by the inside longitudinal length.

Additionally, a combination of the inside longitudinal length and the pair of transverse rims which bound the inside longitudinal length may define a maximum number of the t-flasks that the modular tray may contain where the t-flasks are arranged in a single horizontal array of t-flasks, side by side. In various exemplary embodiments, this combination may be varied to accommodate a different number of side-by-side t-flasks, where each t-flask is held in the modular tray such a longitudinal length of the t-flask is parallel with the pair of transverse rims (and the inside transverse width). For example, in one exemplary embodiment the modular tray may hold three t-flasks in this side-by-side horizontal fashion; whereas in other exemplary embodiments, a given modular tray may hold four, five, six, seven, eight, nine, ten, eleven, or ten t-flasks. Other embodiments for holding a different number of t-flasks is possible without deviating from the scope of this prevent invention.

Additionally, this combination of the inside longitudinal length and the pair of transverse rims may also be varied in various exemplary embodiments, where the modular tray is designed to accommodate one particular standard size of t-flasks, such as T-25, T-57, or T-150.

Note, in general, one particular modular tray is only designed to accommodate one size of t-flask, both in terms of creating the solution angle and in the number of t-flasks the modular tray may hold. Thus, a modular tray for T-25 t-flasks would not work well for T-75 t-flasks.

Additionally, in various embodiments, the pair of longitudinal rims and the pair of transverse rims may form a rim which completely bounds the inside resting surface.

The means for removably coupling one modular tray to another modular tray such that a matrix of modular trays is formed may result in various sized matrixes of modular trays. For example, and without deviating from the scope of the present invention, a one-by-three matrix, a two-by-two matrix, or a two-by-three matrix of modular trays may be formed by utilizing the modular trays means for removably coupling.

Note, the maximum size of a given matrix of modular trays exists because as the matrix increases in number it also increases significantly in weight, since each t-flask contains liquid media. At some point, the increase in weight would strain the means for removably coupling when the matrix is being moved, especially in lifting the matrix. Additionally, aside from the weight limitation, there is a physical dimension limitation presented by increasing the matrix size; i.e., at some point the matrix would become bulky and cumbersome and would be limited by the enclosure, such as a hood, housing the matrix.

In various exemplary embodiments, the means for removably coupling may be realized by utilizing interlocking tabs along an outside perimeter base of the modular tray. That is the means for removably coupling may comprise an outside perimeter base which is in communication with the outside surface of the pair of longitudinal rims and in communication with an outside surface of the pair of transverse rims. The outside perimeter base may comprise a pair of longitudinal bases and a pair of transverse bases. The pair of longitudinal bases may be parallel to the pair of longitudinal rims. The pair of transverse bases may be parallel to the pair of transverse rims. Additionally, the pair of longitudinal bases may be perpendicular to the pair of transverse bases and such that each longitudinal base is separated by each of the transverse bases.

The outside perimeter base may further comprise a plurality of protruding tabs and a plurality of receiving tabs, such that a given pair of protruding tabs and receiving tabs are complimentary to each other permitting removable coupling. In various exemplary embodiments the protruding tabs and receiving tabs may alternate along an outside edge of the outside perimeter base. Furthermore, a protruding tab on one longitudinal base may be located transversely opposite of a complimentary receiving tab on the other longitudinal base. Likewise, a protruding tab on one transverse base may be located longitudinally opposite of a complimentary receiving tab on the other transverse base. A given longitudinal base may have least one protruding tab and one receiving tab. A given transverse base may have one protruding tab while the other transverse base may have one receiving tab.

In terms of visual characteristics, the modular tray may be one or more of substantially transparent or substantially opaque. In some embodiments, the modular tray may be transparent, so to the t-flasks may be seen more readily.

In some embodiments, all the various elements of the modular tray may be integral, i.e., manufactured as a single apparatus. Thus, with respect to materials of construction, the modular tray may be substantially constructed from one or more of: thermoformed plastics, injection molded plastics, machinable plastics, machinable metals, glass, composites, laminates, and/or wood. In various embodiments, the modular tray may be constructed of such injection molded plastics as acrylic, polycarbonate, high density polyethylene (HDPE), nylon, and the like. In some embodiments, the choice of materials of construction may stand up to repeated sterilization and/or depyrogenation techniques, as a particular experiment's quality control demands. Sterilization techniques may include exposing the modular tray to chemical washes (e.g., isopropyl alcohol, bleach, or ethylene oxide [EtO]), steam autoclaves, gamma irradiation, and the like. Depyrogentation may require exposing the modular tray to high dry heat and thus only glass and metals may be suitable.

Note, with respect to the materials of construction, it is not desired nor intended to thereby unnecessarily limit the present invention by reason of such restricted disclosure.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

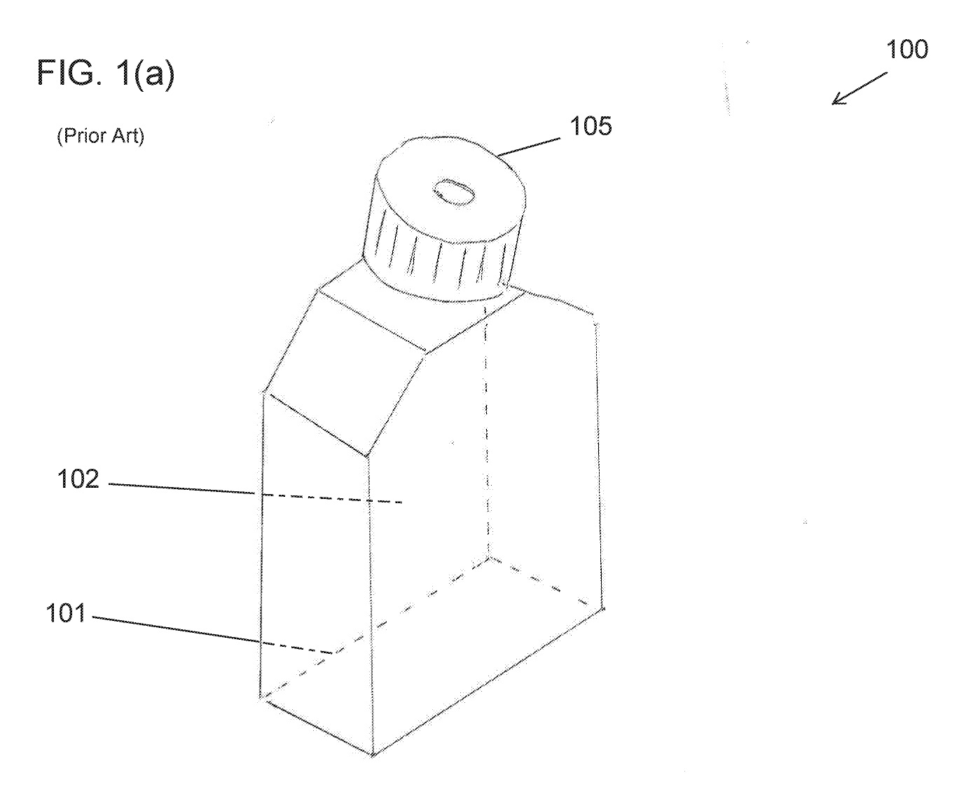

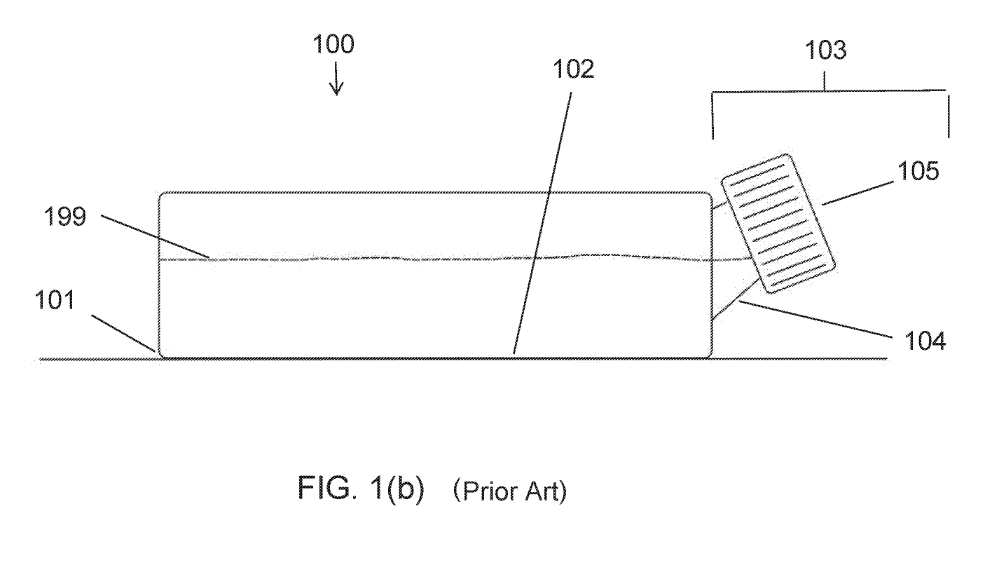

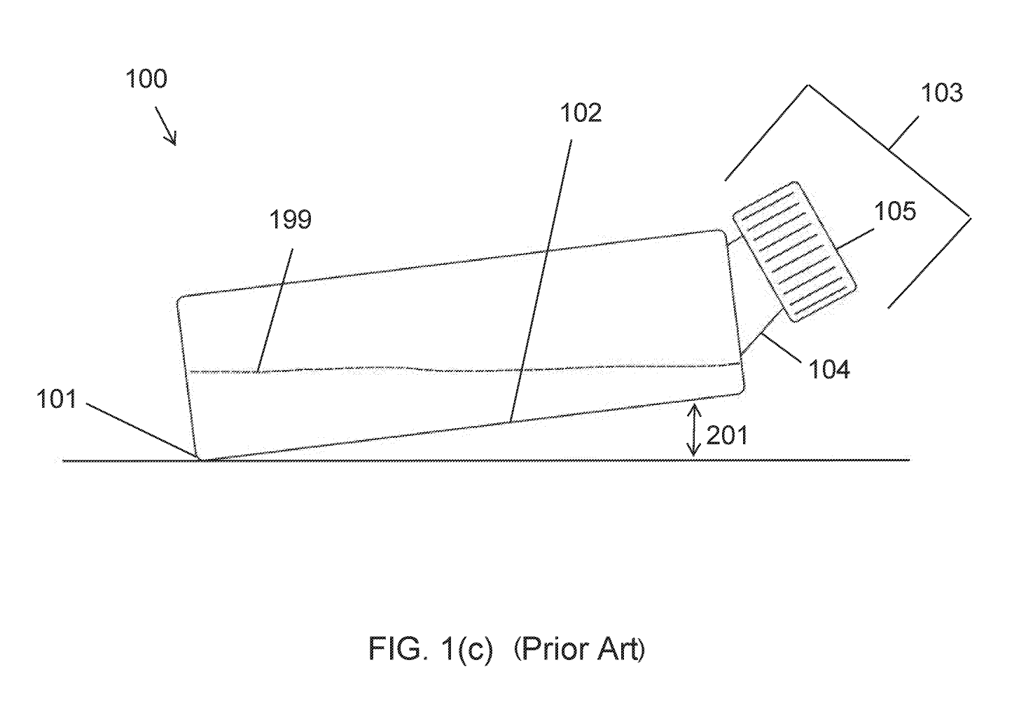

FIG. 1(a) depicts prior art of t-flask 100 upon which this invention operates, shown from a perspective view. As discussed above in the Background of the Invention section, the t-flask 100 is generally transparent plastic or glass vessel in rectangular or trapezoidal prism shapes, with a canted neck and vent cap, used for growing cell cultures. T-flasks 100 are available in a variety of standardized sizes such that the t-flask 100 from any one laboratory supply vendor varies insignificantly in dimensional characteristics across vendors. Examples of standard t-flask 100 sizes are T-25, T-75, and T-150, where the numeral reference generally refers to an approximate surface area in square centimeters (cm²) of bottom surface 102.

In typical use for culturing cells, the t-flask 100 will lay flat upon a flat surface, such that bottom surface 102 and the flat surface are planarly parallel. Bottom surface 102 is one of the two larger surface areas of t-flask 100, such that when bottom surface 102 is lying flat upon a flat surface, vent cap 105 is angled upwards away from the flat surface.

FIG. 1(b) depicts prior art t-flask 100 shown from longitudinal side view, with media inside of t-flask 100, while t-flask 100 lies flat upon a flat surface.

FIG. 1(c) depicts prior art t-flask 100 shown from longitudinal side view, with media inside of t-flask 100, while the t-flask 100 is raised up from a flat surface at solution angle 201. Note, t-flask 100 may be prior art, but solution angle 201 is not.

FIG. 1(b) illustrates a problem that is solved in FIG. 1(c). In FIG. 1(b), when t-flask 100 lies flat upon a flat surface, depending upon the media volume, the media can wet contamination prone regions 103 and substantially increase the probability of contamination occurring, which if it does occur will render an experiment worthless. As noted above, contamination prone regions 103 are the regions were contaminants may enter into the inside of t-flask 100, which namely comprise neck 104 and vent cap 105. Note, in FIG. 1(b) gas-liquid interface 199 is at a level which permits the media in wetting contamination prone regions 103.

Whereas in FIG. 1(c), bottom surface 102 is raised up off of the flat surface, just enough, while keeping bottom edge 101 on the flat surface, such that contamination prone regions 103 are no longer wetted; hence solution angle 201 is formed.

Note, t-flasks 100 may be stacked vertically. Vertical stacks of three or four t-flasks 100 are common in practice. Although not depicted in any of the figures, t-flasks 100 held by modular trays 200 may also be stacked vertically, in addition to the horizontal side-by-side arrangement which is depicted.

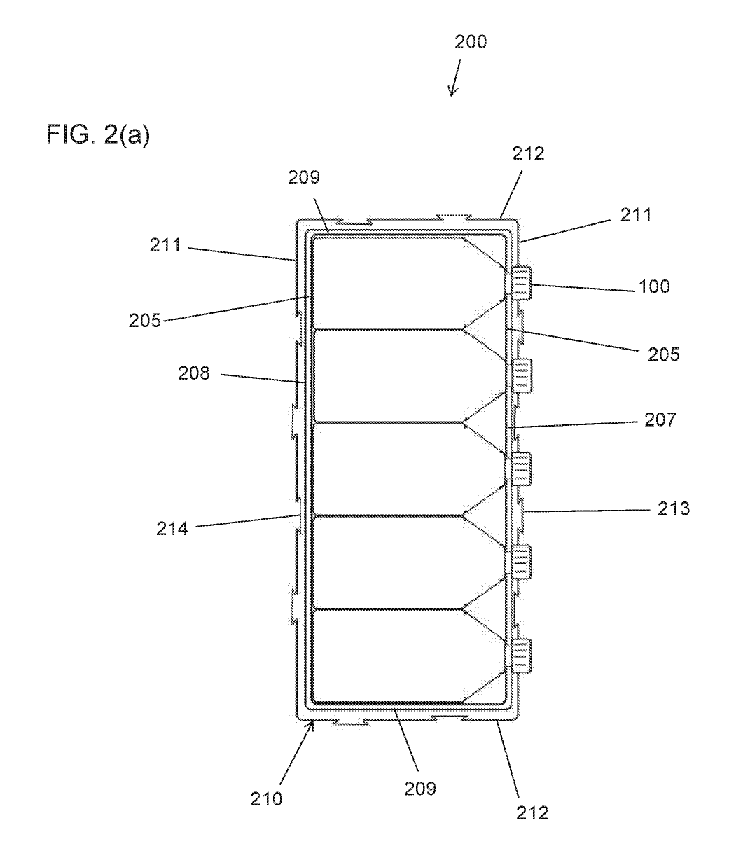

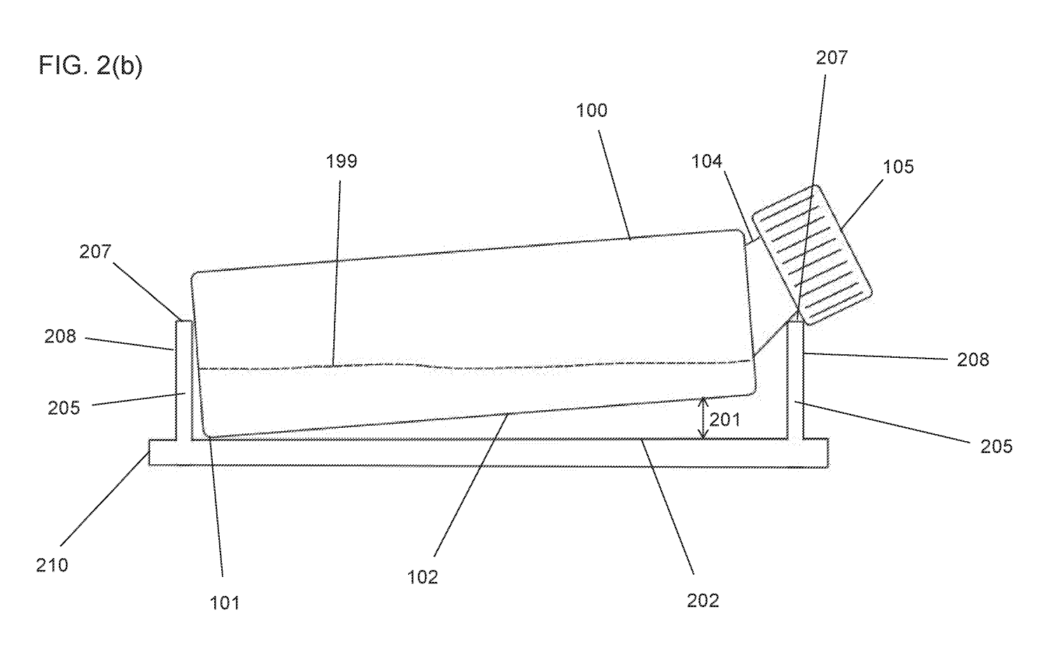

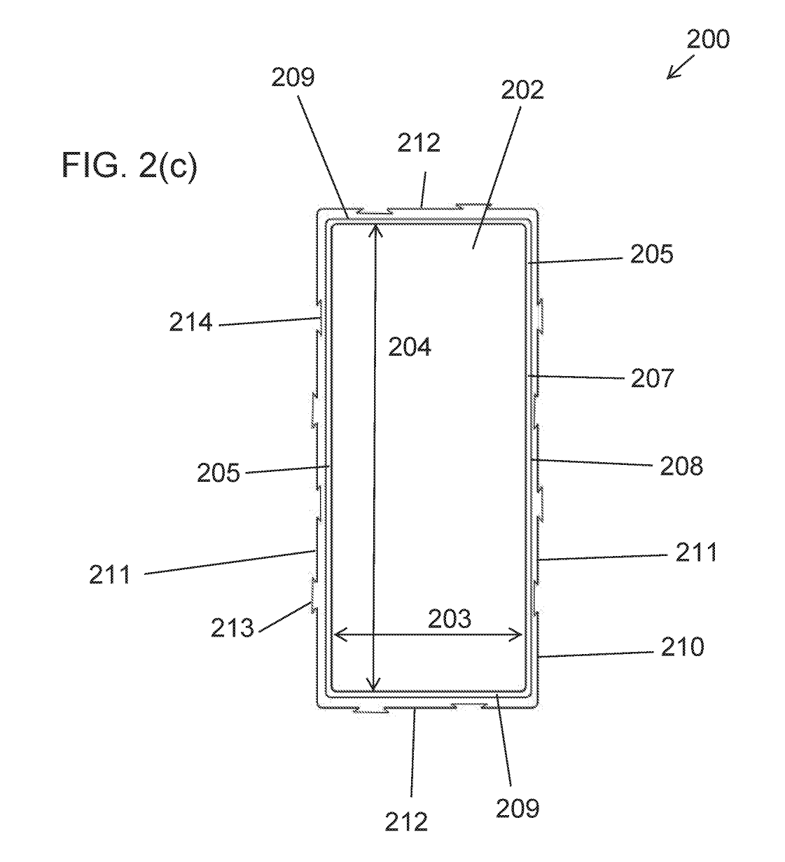

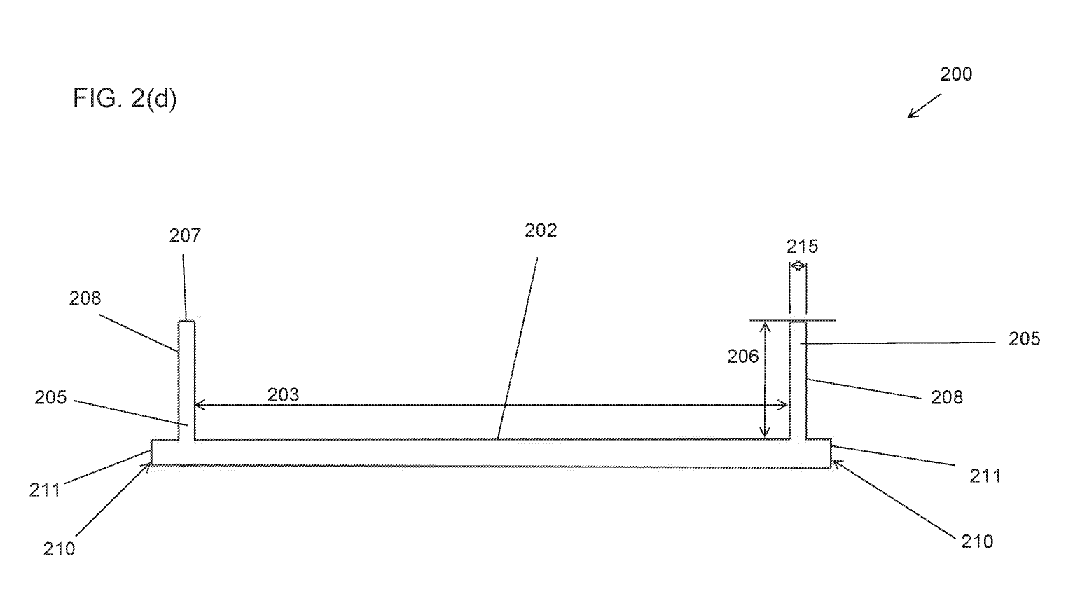

FIG. 2(a) depicts an exemplary embodiment of modular tray 200, removably holding a plurality of t-flasks 100, and shown from a top view. In the exemplary embodiment depicted, inside longitudinal length 204 is sized to accommodate five t-flasks 100 being held horizontally side-by-side, such that the longitudinal length of each t-flask 100 is parallel with inside transverse width 203. Noted, in this particular top view depiction, both inside longitudinal length 204 and inside transverse width are not shown as the t-flasks 100 are residing over those dimensions, but these dimensions are depicted in FIG. 2(c) which shows the same top view but without the t-flasks 100 obscuring the view.

Additionally, from these top views of FIG. 2(a) and FIG. 2(c) the elements allowing for modularization of modular tray 200 are readily shown. That is, the alternating progression of protruding tabs 213 and receiving tabs 214 along outside perimeter 210 is depicted in FIG. 2(a) and in FIG. 2(c).

FIG. 2(b) depicts an exemplary embodiment of modular tray 200, removably holding t-flask 100, shown from a transverse cross-sectional view of modular tray 200, such that solution angle 201 is depicted. Note, transverse cross-sectional view of modular 200 results in a longitudinal cross-sectional view of t-flask 100 when t-flask 100 is properly held in modular tray 200. This transverse cross-sectional view of modular tray 200 removably holding t-flask 100 demonstrates how the combination of dimensions of inside transverse width 203, inside height 206, and the pair of longitudinal rims 205 result in t-flask 100's neck 104 rests upon top edge 207 of one of the longitudinal rims 205 and by doing so forms solution angle 201. Note, inside transverse width 203 and inside height 206 are not readily depicted in FIG. 2(b) because t-flask 100 obscures their view; however, these critical dimensions are depicted in FIG. 2(d) which shows the same transverse cross-sectional view of modular tray 200, but without t-flask 100 obscuring the view. As noted above, the combination of dimensions of inside transverse width 203, inside height 206, and the pair of longitudinal rims 205 are fixed for a given standard size of t-flask 100, in order for solution angle 201 to result.

FIG. 2(c) depicts the exemplary embodiment of FIG. 2(a) from the same top view, but without the plurality of t-flasks 100. When t-flask 100 are removed from the view, inside transverse width 203 and inside longitudinal length 204 are readily apparent. It is inside longitudinal length 204 along with the pair of transverse rims 209 which bound inside longitudinal length 204, that permit a fixed maximum plurality of t-flasks 100 to be held in a side-by-side single horizontal array, such that each t-flask 100's longitudinal length is parallel to the pair of transverse rims 209. For example, in the particular exemplary embodiment depicted in FIG. 2(a), inside longitudinal length 204 is sized to accommodate five side-by-side t-flasks 100.

Whereas, in other exemplary embodiments, not depicted, inside longitudinal length 204 may be sized differently to accommodate a different number of t-flasks 100 to be held in a side-by-side single horizontal array within modular tray 200.

FIG. 2(d) depicts the exemplary embodiment of FIG. 2(b) from the same transverse cross-sectional view of modular tray 200, but without t-flask 100 obscuring the view. Now, inside transverse width 203 and inside height 206 are readily apparent. While, the dimensions of inside transverse width 203 and inside height 206, along with the bounding presence of longitudinal rims 205 is critical in forming a particular solution angle 201 for a given standardized size of t-flask 100; thickness 215 of the longitudinal rims 205 is also important in determining whether vent cap 105 may hang partially below top edge 207, such that outside surface 208 acts as a barrier against vent cap 105 which aids in keeping t-flask 100 from undesirably moving around modular tray 200. Additionally, if thickness 215 is too wide for a given standardized size of t-flask 100, solution angle 201 will be lost, as vent cap 105 will rest upon top edge 207, which increases the angle between bottom surface 102 and inside resting surface 202 so the angle is greater than solution angle 201.

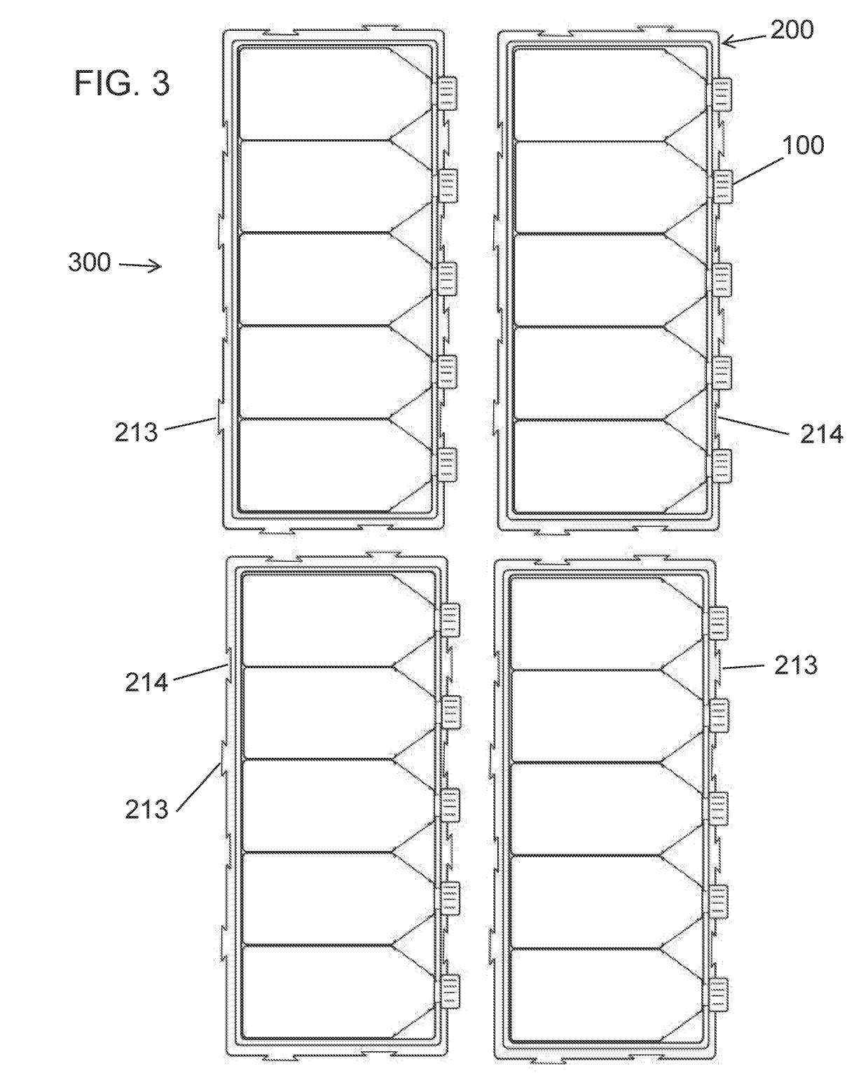

FIG. 3 depicts an exemplary embodiment of matrix 300 of modular trays 200, where each modular tray 200 is removably holding a plurality of t-flasks 100, all shown from an exploded top view. In matrix 300, as depicted, the means for removably coupling one modular tray 200 to another modular tray 200 are a series of protruding tabs 213 and receiving tabs 214, such that each protruding tab 213 may be complimentary and removably mated with a corresponding receiving tab 214 on another modular tray 200.

A two-by-two matrix 300 is depicted in FIG. 3; however, in other exemplary embodiments other arrangements of matrix 300 are possible, for example, and without limiting the scope of the present invention, to a two-by-three matrix 300.

Also, as noted above, the maximum size of a given matrix 300 of modular trays 200 exists because as matrix 300 increases in number of modular trays 200 it also increases significantly in weight, since each t-flask 100 contains liquid media. At some point, the increase in weight would strain the means for removably coupling (e.g., the depicted interlocking protruding 213 and receiving tabs 214) matrix 300 when matrix 300 is being moved, especially in lifting matrix 300. Additionally, aside from the weight limitation, there is a physical dimension limitation presented by increasing matrix 300 size, because at some point matrix 300 would become bulky and cumbersome and would be limited by the housing enclosure, such as a hood, which is housing matrix 300.

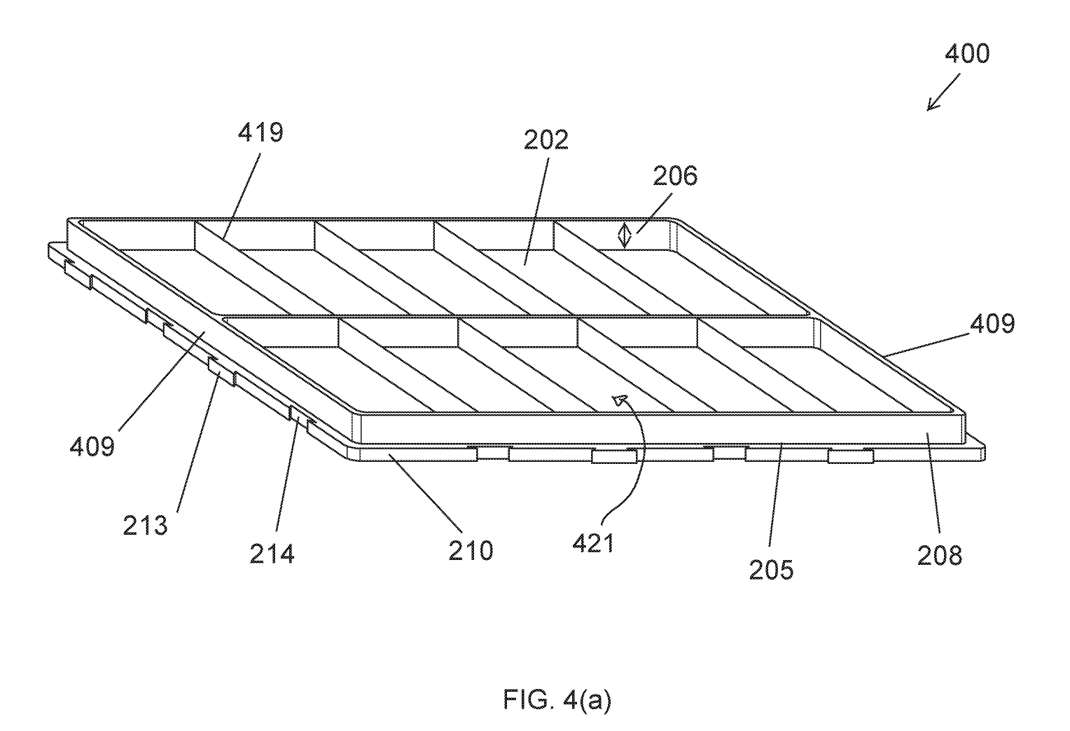

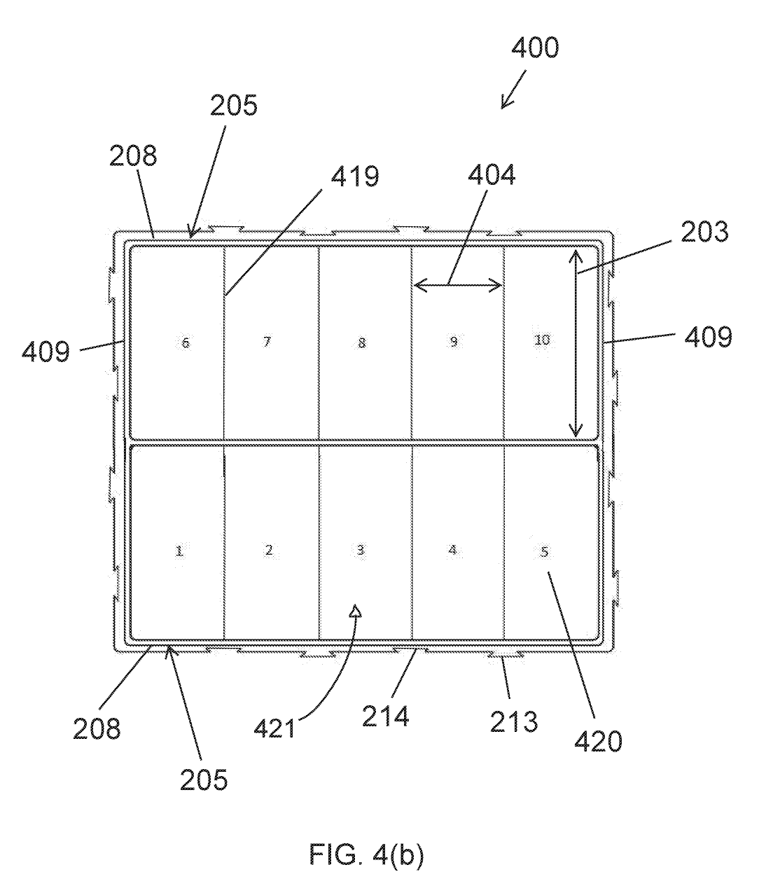

FIG. 4(a) depicts an exemplary embodiment of modular tray 400 which may comprise a plurality of compartments 421, such that each compartment 421 may be sized to accommodate a single t-flask 100 of a particular and same size, shown from a perspective view. And FIG. 4(b) depicts modular tray 400 from a top view.

In the exemplary embodiment of modular tray 400 depicted, a two by five array of compartments 421 is depicted. Each compartment 421 may be substantially rectangular characterized by inside compartment width 404 and inside transverse width 203. Inside compartment width 404 may be sized to accommodate the transverse width of a t-flask 100. Thus, the five inside compartment widths 404, plus the four divider 419 thicknesses approximate inside longitudinal length 204 of modular tray 200. A given t-flask 100 may reside in a given compartment 421, such that a longitudinal length of t-flask 100 is parallel with transverse rims 409, and the transverse width of t-flask 100 is parallel with longitudinal rims 205 (and inside compartment width 404). Each compartment 421 may be sized to form a solution angle 201 with respect to a given standard sized t-flask 100, such that t-flask 100 neck 104 resides upon a given top edge 207. That is, the manner of forming salutation angle 201 for each t-flask 100 held in each compartment 421 operates in the same manner as described above for modular tray 200. Thus, the height of dividers 419 and transverse rims 409 are not critical with respect to forming a solution angle 201, while inside height 206 is such a critical dimension.

Note, in other exemplary embodiments, the formation of compartments 421 may be incorporated into modular trays 200, 501, and 551 as well, simply by the inclusion of a plurality of dividers 419 and adjusting inside width and inside lengths to accommodate thickness of such dividers 419.

Furthermore, as depicted in FIG. 4(b), each compartment 421 may further comprise graphical indicator 420, where such graphical indicators may facilitate the tracking of various cell culturing experiments. As shown in FIG. 4(b) such graphical indicators 420 may comprise Arabic numbers, with one such number corresponding to each compartment 421; however, in other exemplary embodiments other indicators may be used, such as capital letters. Such graphical indicators 420 may be formed during the injection molding process, i.e., the graphical indicator 420 may be a raised protrusion or an indentation taking on the outline of the desired graphical indicator. In other embodiments, such graphical indicators 420 may be separate components which are installed upon each compartment 421, such as by use of adhesives (e.g., applying the graphical indicators 420 as stickers).

Note in other exemplary embodiments, use of graphical indicators 420 may be incorporated into modular trays 200, 501, and 551 as well, simply by the inclusion of such graphical indicator 420 elements as discussed above.

Also as depicted in the FIG. 4 series of figures, modular tray 400 may be modularized in a horizontal fashion using plurality of protruding tabs 213 and plurality of receiving tabs 214, as was modular tray 200 described above.

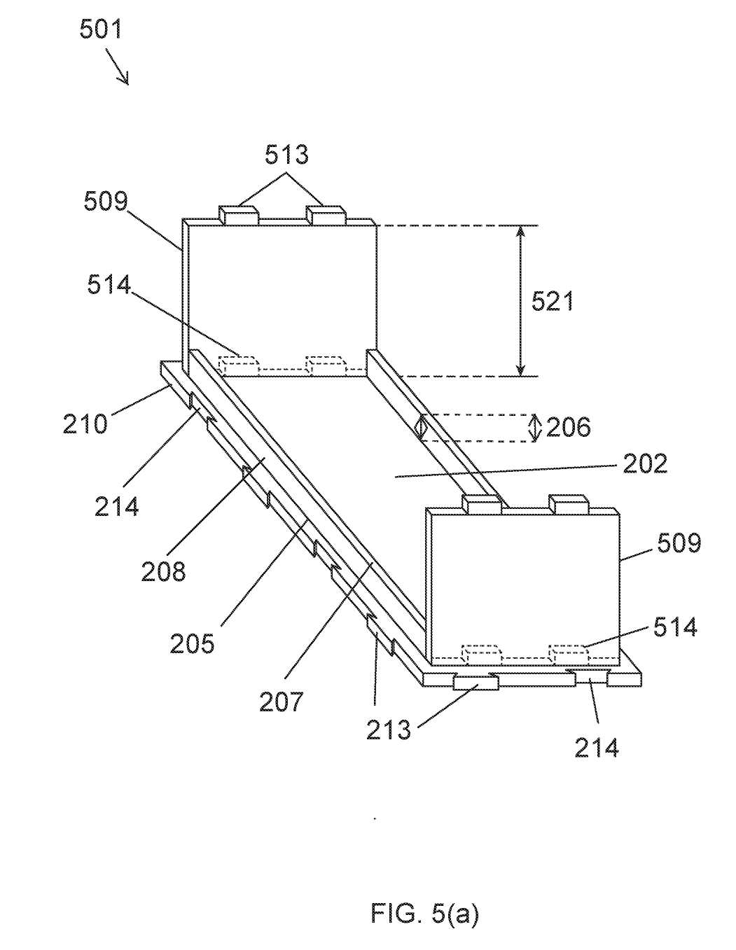

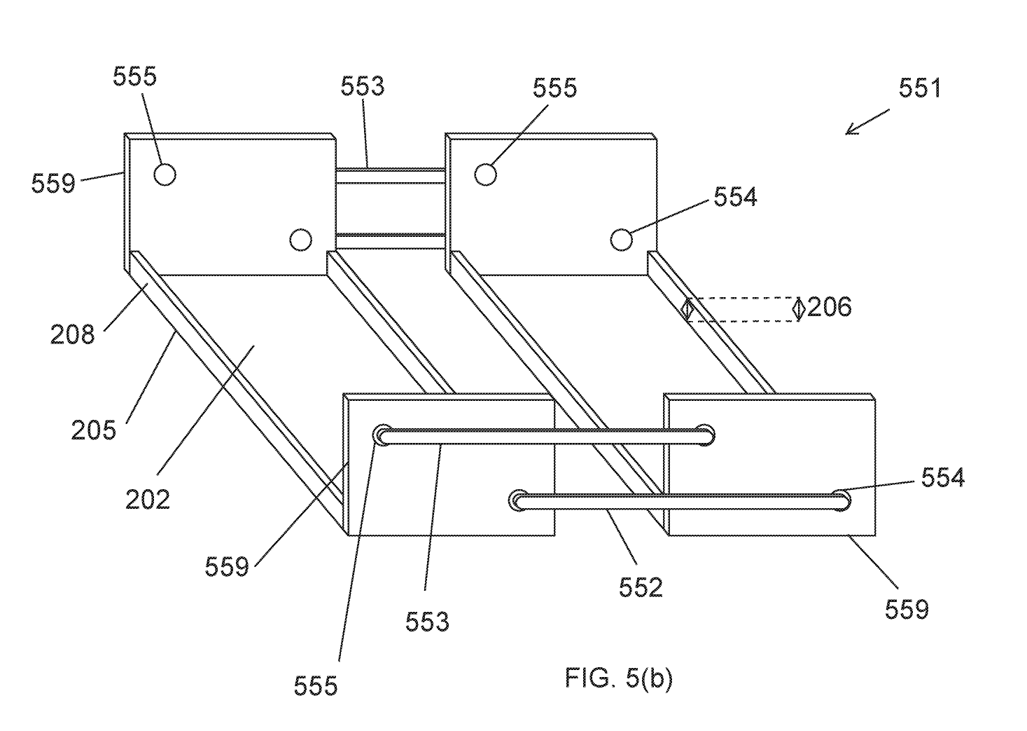

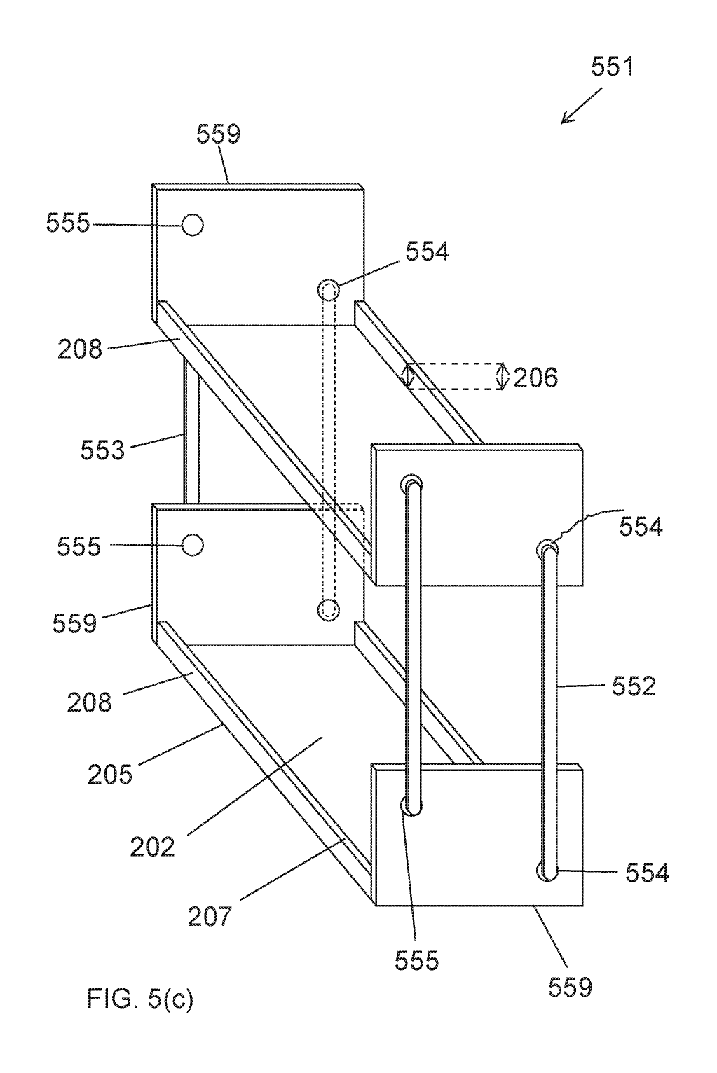

The FIG. 5 series of figures depict two different embodiments of modular trays which may be vertically stackable, as opposed to horizontally modular like modular tray 200 and 400. Vertical stackable modular trays may be desirable, as a more efficient use of space within an incubator may be realized, when such trays are loaded at solutions angles 201 with respective t-flasks 100 containing cell cultures and media.

FIG. 5(a) depicts an exemplary embodiment of vertically stackable modular tray 501, shown from a perspective view. Here, modular tray 501 may comprise features allowing modular trays 501 to be stacked vertically upon each other. For example, a first modular tray 501 may receive another modular tray 501 on top of the first modular tray 501, or alternatively, the first modular tray 501 may be stacked on top of another modular tray 501.

In order to accomplish such vertical stacking properties, modular tray 501 may comprise vertical tabs 513 and receiving ports for vertical tabs 514, such that vertical tabs 513 of a first modular tray may enter and lock into receiving ports 514 of another modular tray and thus allow modular trays 501 to be vertically stacked. Each modular tray 501 may comprise a plurality of vertical tabs 513, which may located upon a top surface of each transverse rim 509.

As for receiving ports 514, each receiving port is sized to receive a given vertical tab 513, i.e. each receiving port further comprises a cavity sized to receive a given vertical tab 513 and the geometry of each receiving port 514 may be such to frictionally grip a vertical tab 513 when it may be inserted into said receiving port 514.

Numerically, the number of receiving ports 514 may be equal to the number of vertical ports 513, both in terms of total number and with respect to the number of vertical tabs 513 on the top of a given transverse rim 509. For example, as depicted in FIG. 5(a), each transverse rim 509 may comprise two vertical tabs 513 on top of each transverse rim 509. Thus, there may be four vertical tabs, two to each transverse rim 509. And thus, there may be four receiving ports 514, two to the bottom of each transverse rim 509.

The opening of each receiving port 514 may be on the bottom surface of modular tray 501, which may be a generally planar surface. Further, in order to provide vertical stacking stability, a given receiving port 514, with an entry point on the bottom, may also be positionally fixed such that for each vertical tab 513 located on the top of a transverse rim 509, there may be a receiving port 514 which longitudinally opposes the given vertical tab 513, and where both the vertical tabs 513 and the receiving ports 514 are located within the same plane as the transverse rim 509. Thus, for each vertical tab 513, there is a paired complimentary receiving port 514.

Additionally, each transverse rim 509 may comprise a height 521, which may of such a height to allow a plurality of t-flasks 100 to be vertically stacked (e.g., three vertically stacked t-flasks 100) upon inside surface 202 of the a given modular tray 501. See e.g., FIG. 5(a).

FIG. 5(b) depicts embodiment of two modular trays 551 which may be either in a horizontal configuration or a vertical configuration with respect to each other, shown from a perspective view. In FIG. 5(b) the horizontal configuration is depicted. In FIG. 5(c) the vertical configuration is depicted, also from a perspective view.

Each pair of modular trays 551 may comprise two modular trays 551 which may either be in the horizontal configuration or the vertically stacked configuration. Each of these two trays 551 may be in communication with each other via a pair of struts (e.g., 552 and 553) affixed to a respective pair of transverse rims 559, with one member of the pair of transverse rims 559 located on one of the modular trays 551 and the other member of the pair of transverse rims 559 located on the other modular tray 551. Reference numeral 552 may be lower strut 552; and reference numeral 553, may be upper strut 553. Thus, as depicted in the FIG. 5 series of figures, each pair of modular trays 551 may comprise four struts, with two such struts securing one transverse rim 559 of one tray 551 to a transverse rim 559 of the other tray 551. And the other two remaining struts functioning and positioned in the same fashion with respect to the remaining two transverse rims 559. Additionally, each of the four struts may comprise an identical length, which may aid in stability.

Each strut (552 and 553) may comprise two terminal ends, where each terminal end may terminate in a ratchet type locking mechanism (554 and 555), which serves two functions: (1) to secure each strut to a transverse rim 559 of each tray 551; and (2) to permit rotational movement in a controlled fashion, such that the pair of trays 551 may be translated from the horizontal configuration to the vertical configuration and vice-versa. Reference numeral 554 may be lower ratchet type locking mechanism 554; and reference numeral 555, may be upper ratchet type locking mechanism 555. Because there may be four struts (two of 552 and two of 553) in total, where each strut may comprise two terminal ends, then there may be eight ratchet type locking mechanisms (four 554 and four 555), to secure each strut terminal end to a respective transverse rim 559.

To avoid a pair of struts (552 and 553) from colliding into each other during transitions between the two configurations, one strut, lower strut 552 (with respect to the horizontal configuration) may be secured to lower corners a pair of respective transverse rims 559, while the remaining strut of the pair, the upper strut 553 may be secured to upper corners of the pair of respective transverse rims 559. Such upper corner and such lower corner may be such corners which are diagonally opposing each other. Note, in the vertical configuration, each of the four struts may also be in a vertical position, while in the horizontal configuration, each of the four struts may be in a horizontal position.

Various embodiments of modular trays for holding a plurality of t-flasks at a solution angle has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A modular tray for holding a plurality of cell culture t-flasks at a solution angle, comprising:
an inside resting surface for receiving bottom edges of the plurality of cell culture t-flasks; wherein the inside resting surface comprises:
an inside transverse width; and
an inside longitudinal length, which is perpendicular to the inside transverse width;
a pair of longitudinal rims which are parallel to the inside longitudinal length, that arise perpendicularly from the inside resting surface, and where each longitudinal rim is separated by the inside transverse width such that the pair of longitudinal rims bound the inside transverse width, and where the pair of longitudinal rims rise to an inside height at a top edge of each of the pair of longitudinal rims;
wherein a combination of the inside transverse width, the inside height, and the pair of longitudinal rims force necks of the plurality of cell culture t-flasks to removably rest upon the top edge of one of the pair of longitudinal rims and such that vent caps of the plurality of cell culture t-flasks hang partially below the top edge of the one longitudinal rim towards an outside surface of the one of the pair of longitudinal rims such that the outside surface of that one of the pair of longitudinal rims provides a barrier against the vent caps maintaining the solution angle by preventing the plurality of cell culture t-flasks from lying flat within the inside resting surface;
a pair of transverse rims which are parallel to the inside transverse width, that are perpendicular to the pair of longitudinal rims, that arise perpendicularly from the inside resting surface, and where each transverse rim of the pair of transverse rims is separated by the inside longitudinal length, and where a combination of the inside longitudinal length and the pair of transverse rims which bound the inside longitudinal length define a maximum number of the plurality of cell culture t-flasks that the modular tray removably holds where the plurality of cell culture t-flasks are arranged in a single horizontal array of cell culture t-flasks, side by side, along the inside longitudinal length;
wherein the pair of longitudinal rims and the pair of transverse rims form a rim which completely bounds the inside resting surface;
wherein each cell culture t-flask selected from the plurality of cell culture t-flasks is removably held by the modular tray at the solution angle such that media within each cell culture t-flask does not wet a contamination prone region of each cell culture t-flask that is removably held by the modular tray.

2. The modular tray according to claim 1, wherein the modular tray further comprises a means for removably coupling one modular tray to another modular tray such that a matrix of modular trays is formed.

3. The modular tray according to claim 1, wherein the modular tray is substantially transparent or opaque.

4. The modular tray according to claim 1, wherein the modular tray is substantially constructed of one or more of: a thermoplastic, an injection molded plastic, a machinable plastic, a machinable metal, a 3D printed thermoplastic, a 3D printed metal, a glass, a composite, a laminate, or a wood.
